(19) United States
(12) Patent Application Publication
(10) Pub. No.: US 2025/0102745 A1
(43) Pub. Date: Mar. 27, 2025

(54) ROBUST WAVEGUIDE ALIGNMENT MECHANISM

(71) Applicant: Intel Corporation, Santa Clara, CA (US)

(72) Inventors: Mohanraj Prabhugoud, Portland, OR (US); David Shia, Portland, OR (US); Hari Mahalingam, San Jose, CA (US); John M. Heck, Berkeley, CA (US); John Robert Macdonald, Linlithgow (GB); Duncan Peter Dore, Glasgow (GB); Eric J. M. Moret, Beaverton, OR (US); Nicholas D. Psaila, Lanark (GB); Sang Yup Kim, Sunnyvale, CA (US); Shane Kevin Yerkes, Placitas, NM (US); Harel Frish, Albuquerque, NM (US)

(73) Assignee: Intel Corporation, Santa Clara, CA (US)

(21) Appl. No.: 18/475,907

(22) Filed: Sep. 27, 2023

(51) Int. Cl. G02B 6/42

(52) U.S. Cl. CPC G02B 6/4231; G02B 6/4212; G02B 6/428

(57) ABSTRACT

In one embodiment, a device includes a fiber array unit (FAU) coupled to a photonics integrated circuit (PIC) die. The PIC die includes a cavity defined at an edge of the PIC die, with outer edges of the cavity being formed at an angle less than 90 degrees with respect to a bottom surface of the cavity. The PIC die further includes first waveguides protruding into the cavity of the PIC die. The FAU includes a shelf portion extending from a body portion, and a plurality of second waveguides protruding from an outer edge of the shelf portion opposite the body portion. The FAU further includes alignment structures on outer edges of the shelf portion that are in contact with the angled edges of the cavity of the PIC die.

### BACKGROUND

Currently, glass core fiber-to-silicon waveguide alignment is achieved using v-grooves that are cut in a silicon chip, e.g., in the substrate of a photonics integrated circuit (PIC) die. However, as the density of the waveguides increases and/or the pitch of the waveguides reduces, v-groove alignment may be limited, e.g., due to fiber diameter or reduced throughput in manufacturing.

### BRIEF DESCRIPTION OF THE DRAWINGS

FIGS. 1A-1C illustrate examples of current integrated circuit packages incorporating fiber arrays attached to photonics integrated circuit (PIC) dies.

FIGS. 2A-2B illustrate an example PIC die that includes an alignment mechanism in accordance with embodiments herein.

FIGS. 3A-3B illustrates an example fiber array unit (FAU) that includes an alignment mechanism in accordance with embodiments herein.

FIG. 4 illustrates another example FAU that includes an alignment mechanism in accordance with embodiments herein.

FIGS. 5A-5C illustrate the example PIC die of FIGS. 2A-2B and the FAU of FIGS. 3A-3B coupled together.

FIG. 6 is a top view of a wafer and dies that may be included in a microelectronic assembly, in accordance with any of the embodiments disclosed herein.

FIG. 7 is a cross-sectional side view of an integrated circuit device that may be included in a microelectronic assembly, in accordance with any of the embodiments disclosed herein.

FIG. 8 is a block diagram of an example electrical device that may include a microelectronic assembly, in accordance with any of the embodiments disclosed herein.

### DETAILED DESCRIPTION

Embodiments herein provide robust and scalable waveguide alignment mechanisms. In certain embodiments, for example, a waveguide array of a photonics integrated circuit (PIC) die may be aligned with a waveguide array of a fiber array unit (FAU) in a passive manner based on features on each component. The alignment may be achieved by alignment structures on the FAU that interact with a trench formation in the PIC die when mated together. Thus, embodiments may allow for alignment of waveguides without the need for multiple v-grooves formed in the PIC die.

Aspects of the present disclosure can provide advantages over conventional v-groove attachment techniques. For example, embodiments of the present disclosure provide a coupler design with reduced complexity as compared to traditional v-groove approaches. In addition, because the alignment features of the present disclosure are farther away from the waveguides than the traditional v-grooves, the attachment may be less sensitive to debris or cleaning as compared to v-groove approaches. Embodiments herein can also provide a more uniform IME (Index Matching Epoxy) bond-line thickness when attaching coupler to silicon. Furthermore, embodiments herein may be more scalable for increased waveguide densities and/or channel count increases, and can enable non-uniform pitch scaling (i.e., waveguide arrays that do not include a uniform spacing between the waveguides).

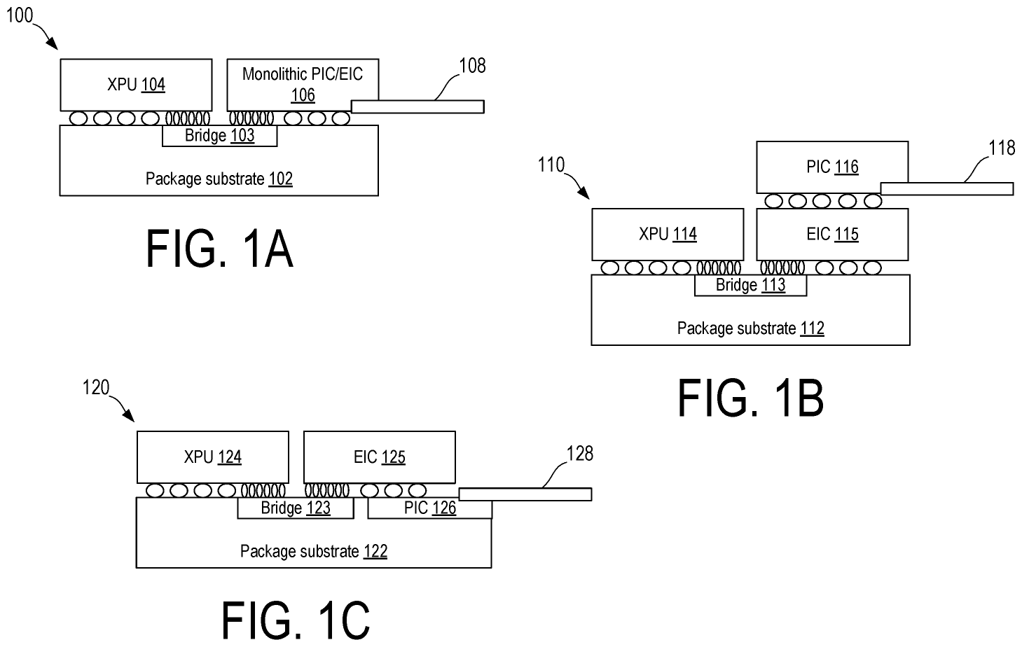

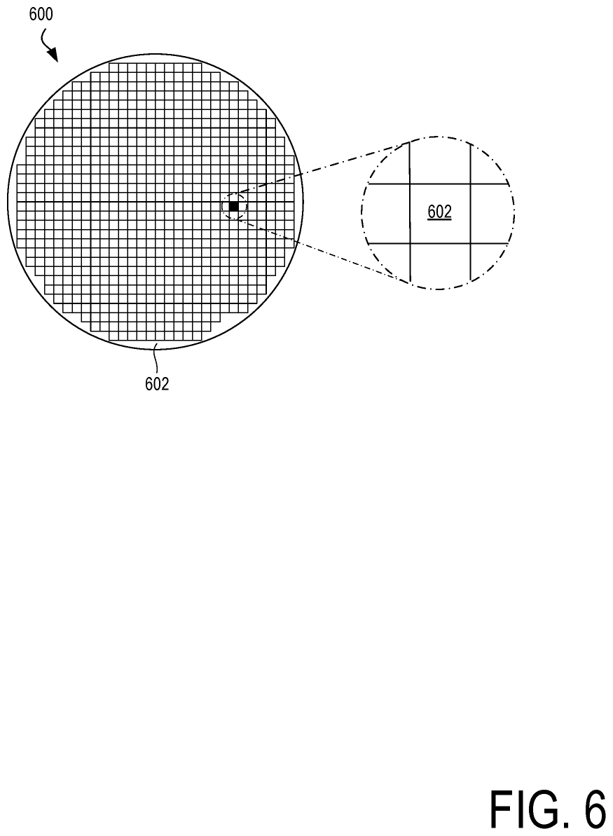

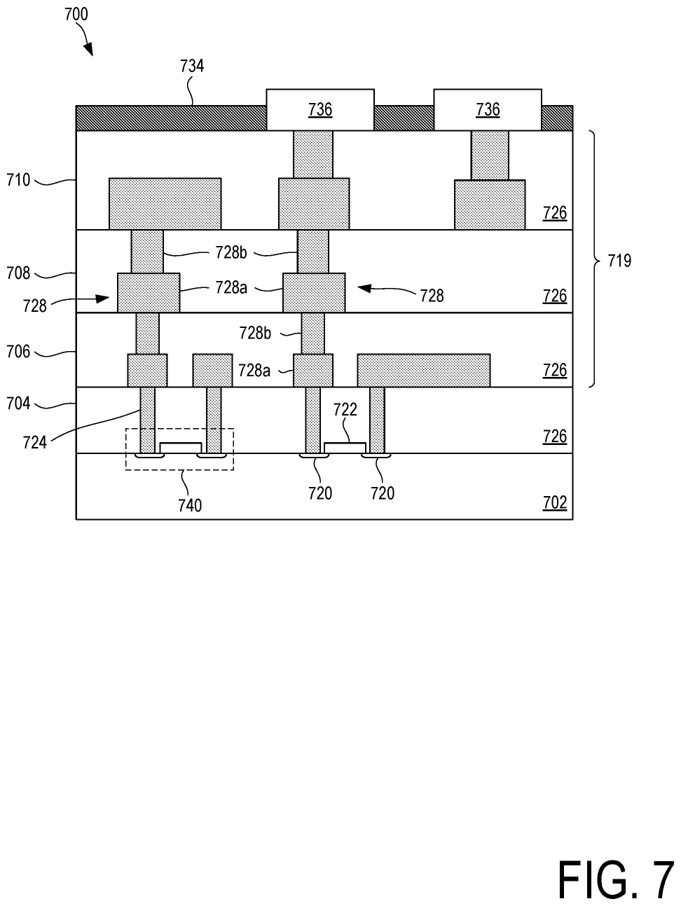

FIGS. 1A-1C illustrate examples of integrated circuit packages 100, 110, 120 incorporating fiber arrays attached to photonics integrated circuit (PIC) dies. The example packages can implement the alignment features described further below. In each example shown, the package includes a package substrate (e.g., 102, 112, 122) with embedded bridge circuitry (e.g., 103, 113, 123) that interconnects processing circuitry (XPU) with a photonics integrated circuit (PIC) and an electronic integrated circuit (EIC). The bridge circuitry may be, e.g., an Intel® embedded multi-die interconnect bridge (EMIB). Any of the XPU, PIC, and EIC can be manufactured from a wafer, similar to the dies 602 of FIG. 6, and the XPU may be an integrated circuit device similar to the integrated circuit device 700 of FIG. 7. The package substrate in each example may provide interconnections between a main circuitry board (e.g., a mother board or main board) and the XPU and/or PIC/EIC.

The example shown in FIG. 1A includes a monolithic PIC/EIC die 106 that is interconnected with an XPU 104 via bridge circuitry 103 in the package substrate 102. The example shown in FIG. 1B includes a PIC die 116 on top of an EIC die 115, with the EIC die 115 being interconnected with the XPU 114 via the bridge circuitry 113 in the package substrate 112. The example shown in FIG. 1C includes a PIC die 126 embedded into the package substrate 122. The PIC die 126 is connected to an EIC die 125 on top of the package substrate 122 and is interconnected with the XPU 124 via bridge circuitry 123. As used herein, a PIC die may also be referred to as a PIC, and an EIC die may also be referred to as an EIC.

The PIC in each example may include circuitry to receive optical signals from a source (e.g., the fiber 108, 118, 128), convert the optical signals to electrical signals, and provide the electrical signals to other circuitry (e.g., to the EIC and/or the XPU). Likewise, the PIC includes circuitry to receive electrical signals (e.g., from the EIC and/or the XPU), generate optical signals based on the electrical signals, and provide the optical signals to the fiber. The PIC may include one or more lasers or other light sources, detectors, amplitude and/or phase modulators, filters, splitters, amplifiers, interferometers, microring resonators, gratings, squeezed or other quantum light sources, etc. The PIC circuitry may perform other functions beyond converting optical signals to electrical signals or vice versa, e.g., matrix multiplication, quantum logic gates, optical compute gates, etc. The EIC may include circuitry to control and/or drive the circuitry within the PIC and/or other electrical circuitry for processing the signals from the PIC. For instance, the EIC may include components such as, for example, transimpedance amplifiers (TIA), serializer/deserializer (SERDES) circuits, driver circuits, etc. The optical signals may be received from an array of fiber, e.g., a fiber pigtail connection, that is coupled to the PIC, e.g., via v-groove connections.

The XPU in each example may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units.

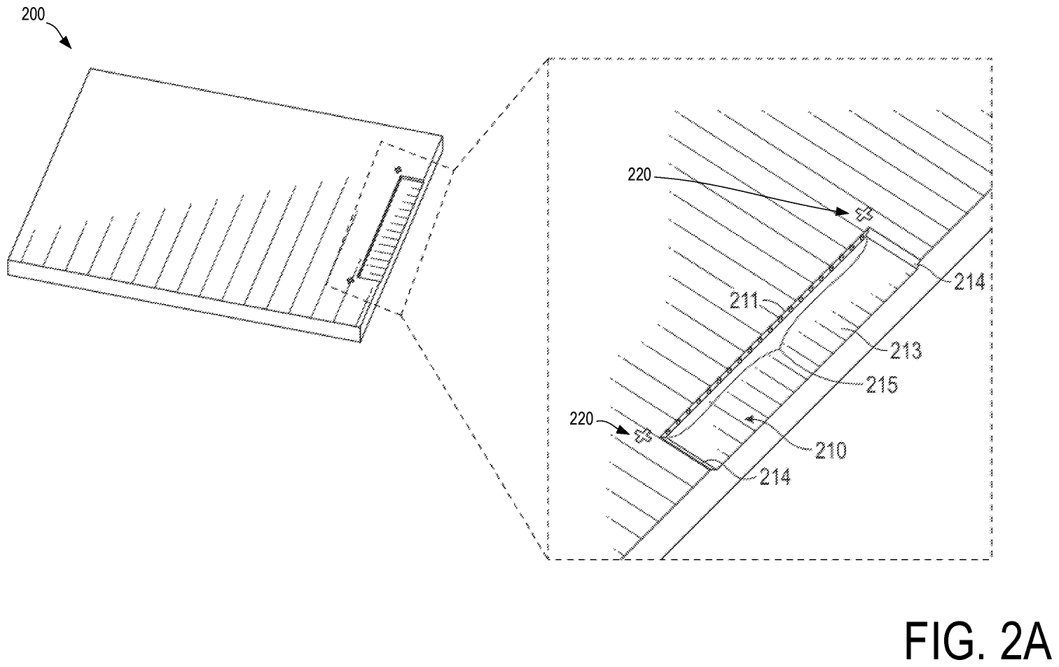

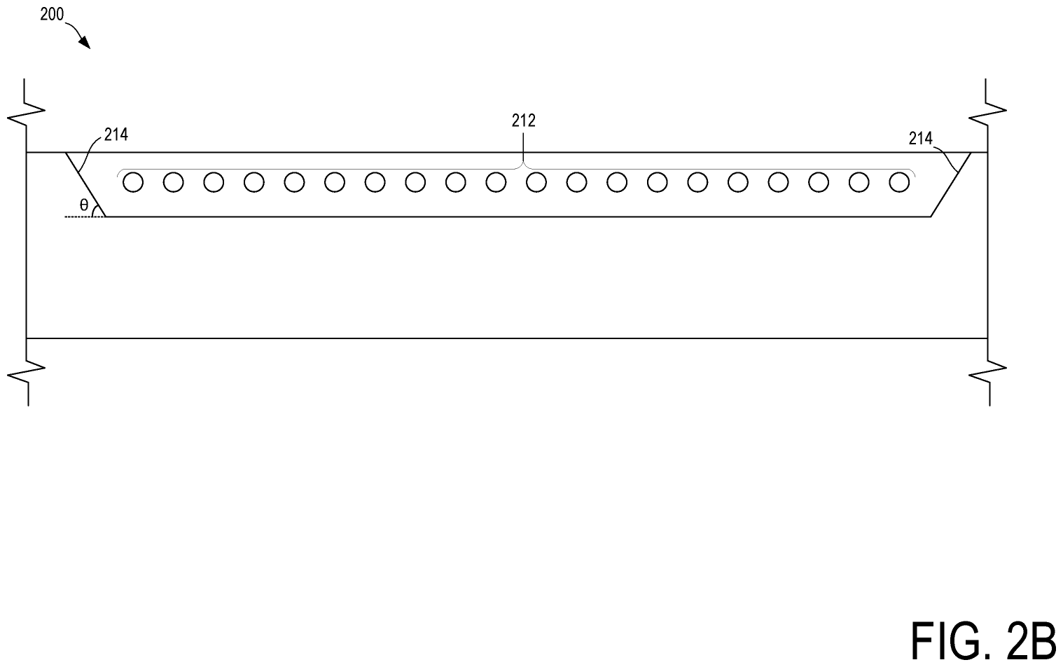

FIGS. 2A-2B illustrate an example PIC die 200 that includes an alignment mechanism in accordance with embodiments herein. As shown, the PIC die 200 includes a cavity 210 formed at an edge of the die 200. The cavity 210 is defined in the substrate of the PIC die 200 by a first edge 211, which may be substantially perpendicular (e.g., between 85-95 degrees) with the bottom surface 213 of the cavity, and second and third edges 214. In the example shown, the cavity 210 is rectangular in shape, i.e., the edges 211 and 214 are substantially perpendicular with the edges 214 being substantially parallel with one another (e.g., ±5 degree from being parallel). However, the cavity 210 may be formed in any other suitable shape (e.g., trapezoidal, where the edges 211, 214 are not perpendicular). The edges 214 of the cavity 210 are formed an angle with respect to the bottom surface 213 (the angle e in the example shown). The angle of the edges 214 may be based on the material of the PIC die and may be based on the inherent crystalline structure of the substrate material. For example, a die 200 with a silicon substrate may have edges 214 at an angle θ that is approximately 45 degrees (e.g., between 44-46 degrees). This angle θ may also be the same or similar angle at which conventional v-grooves may be formed within the substrate of a die.

The die 200 further includes a plurality of waveguides 215 that protrude into the cavity 210 from the die 200. The waveguides 215 may be coupled to one or more optical components within the die 200, e.g., those described above with respect to PICS. In the example shown, the waveguide spacing is uniform (e.g., 250 um between each waveguide); however, other embodiments may implement non-uniform spacing or shorter spacing between the waveguides 215.

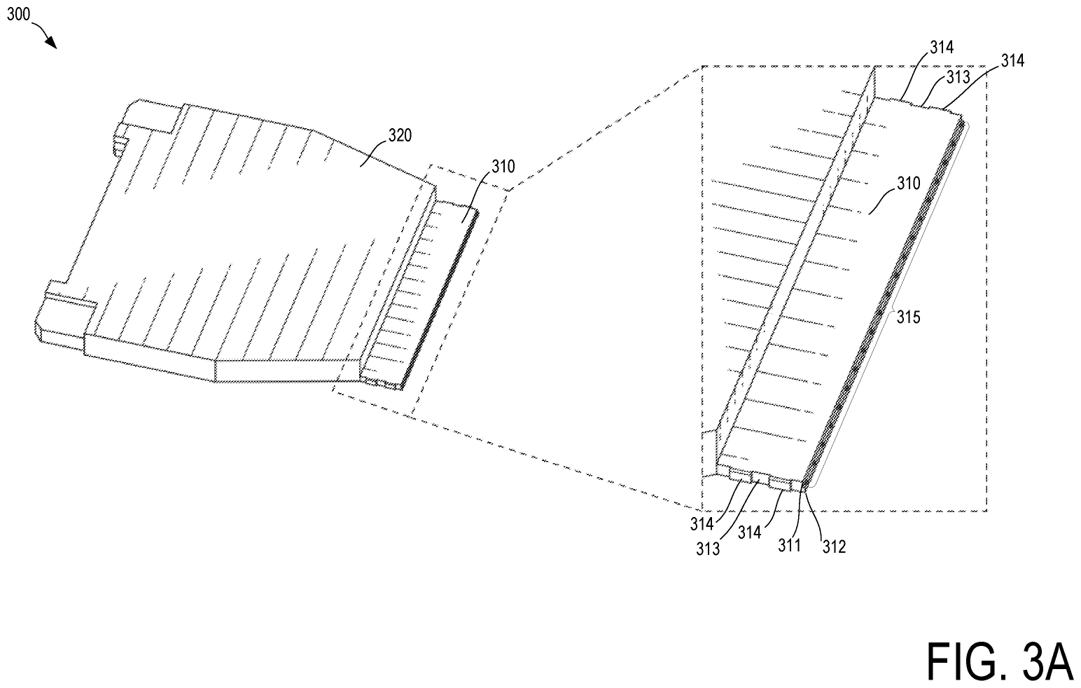

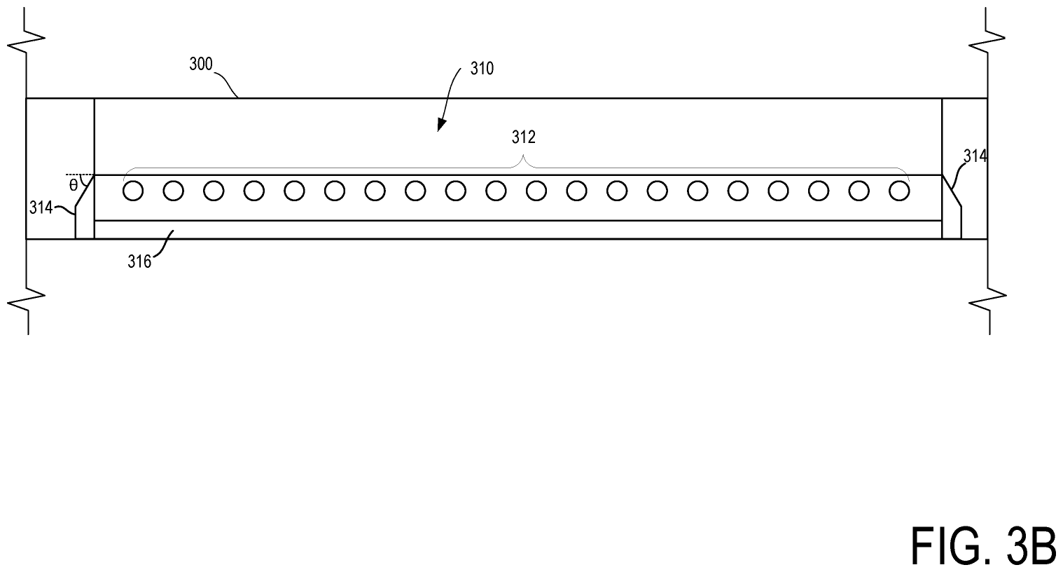

The die 200 further includes alignment fiducials 220 on the top surface of the die 200, near edges of the cavity. The alignment fiducials 220 may aid in the attachment and alignment of a fiber array unit (FAU) (e.g., the FAU 300 of FIGS. 3A-3B) when the FAU is coupled to the die 200. For instance, the fiducials 220 may be used by an optical alignment system as a point of reference when attaching the FAU. Although shown in a particular location on the top surface of the die 200, the fiducials 220 may be located in any suitable location on the surface of the die 200.

FIGS. 3A-3B illustrates an example fiber array unit (FAU) 300 that includes an alignment mechanism in accordance with embodiments herein. In particular embodiments, the FAU 300 may be formed entirely of glass, with waveguides 315 being laser written (e.g., using a femtosecond laser) into the glass structure. However, in other embodiments, the FAU 300 may be implemented using waveguides 315 that are within another type of housing (e.g., a plastic or other type of housing).

As shown, the FAU 300 includes a shelf formation 310 that extends from a main body 320 of the FAU 300. The shelf formation is defined by a number of edges, including a first edge 311 opposite the body 320, a second edge 312 parallel with the first edge 311 and extending slightly further outward from the first edge 311, and side edges 313 that connect the first edge 311 and second edge 312 with the main body 320. In the example shown, the shelf formation 310 is rectangular (to match the shape of the cavity 210); however, the shelf formation 310 may be formed in any other suitable shape. For example, the shape of the shelf formation may match (or substantially match) the shape of a cavity in a PIC die to which the FAU is to be attached. So, a trapezoidal shelf formation 310 may be implemented where the PIC die cavity is trapezoidal as well. The FAU 300 includes waveguides 315 of the FAU 300 protrude from the first edge 311 of the shelf formation 310 as shown. In some embodiments, the second edge 312 may be substantially aligned with the ends of the waveguides 315, while in other embodiments the second edge 312 may extend slightly beyond the ends of the waveguides 315.

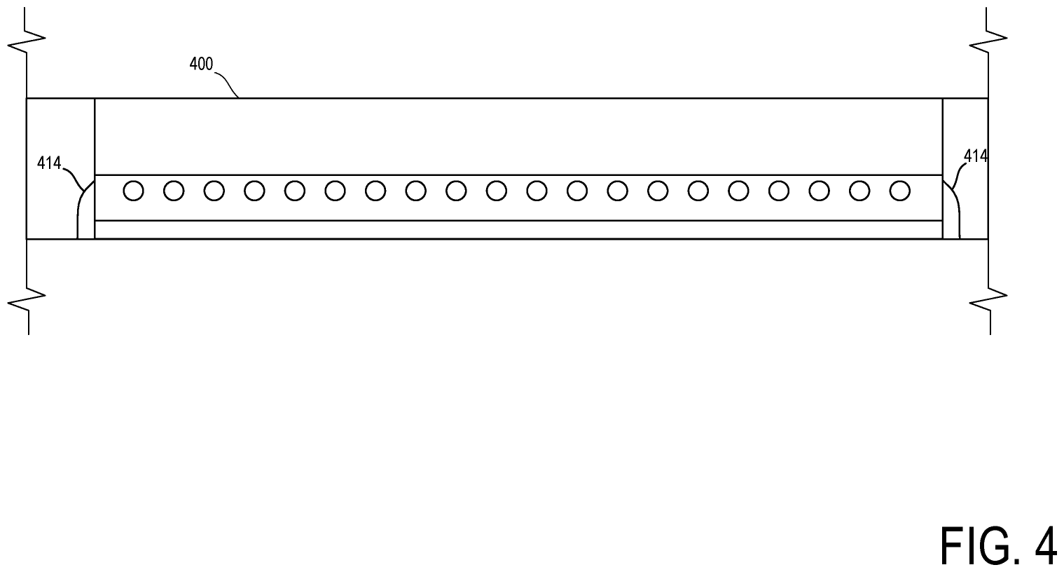

The shelf formation 310 further includes a plurality of alignment structures 314 on the outer edges 313. The alignment structures 314 are shaped such that they interact with the angled edges 214 of the PIC die 200 when the FAU 300 is coupled to the PIC die 200. That is, when the FAU 300 is coupled to a PIC die (e.g., 200), the alignment structures 314 will be in contact with the angled edges (e.g., 214) of a cavity formed in the die. This passive interaction allows for robust alignment of the waveguides 315 with the waveguides of the PIC die (e.g., 215). In the example shown, the alignment structures 314 are formed with an angled edge that matches the angle of the angled edge of the cavity within the PIC due (e.g., as shown in FIG. 4B). However, other embodiments may include alignment structures 314 with different shapes for interaction with the angled edges of the PIC die.

FIG. 4 illustrates another example FAU 400 that includes an alignment mechanism in accordance with embodiments herein. The example FAU 400 includes the same features as the FAU 300, but includes alignment structures 414 with a curved edge as shown. The curved edge may allow for less material interaction with the angled edges of the PIC die, which may advantageously reduce friction between the FAU and the die.

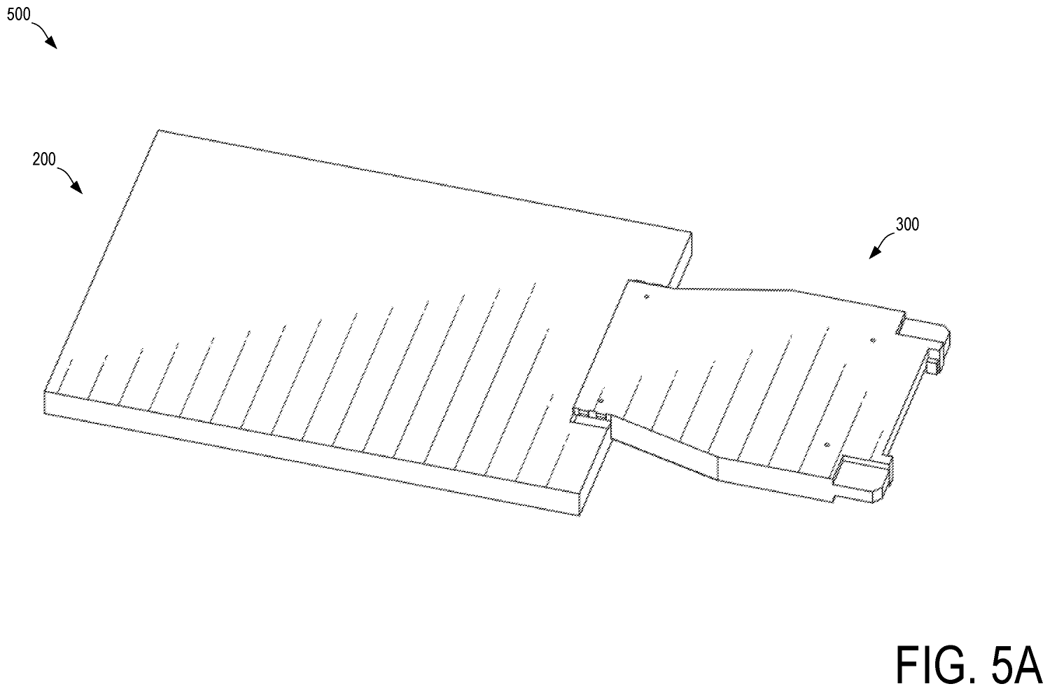

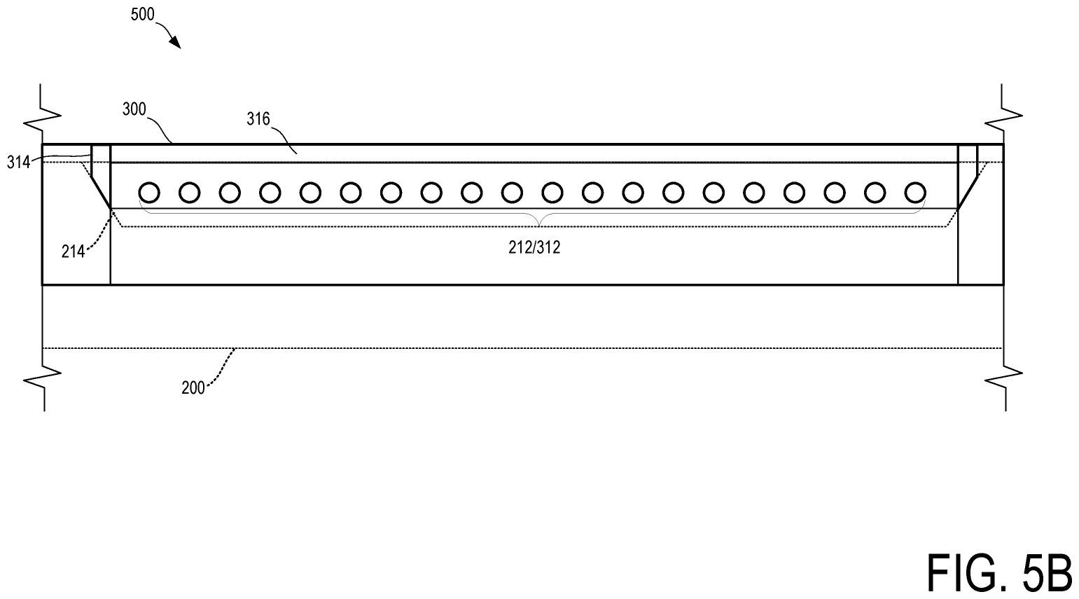

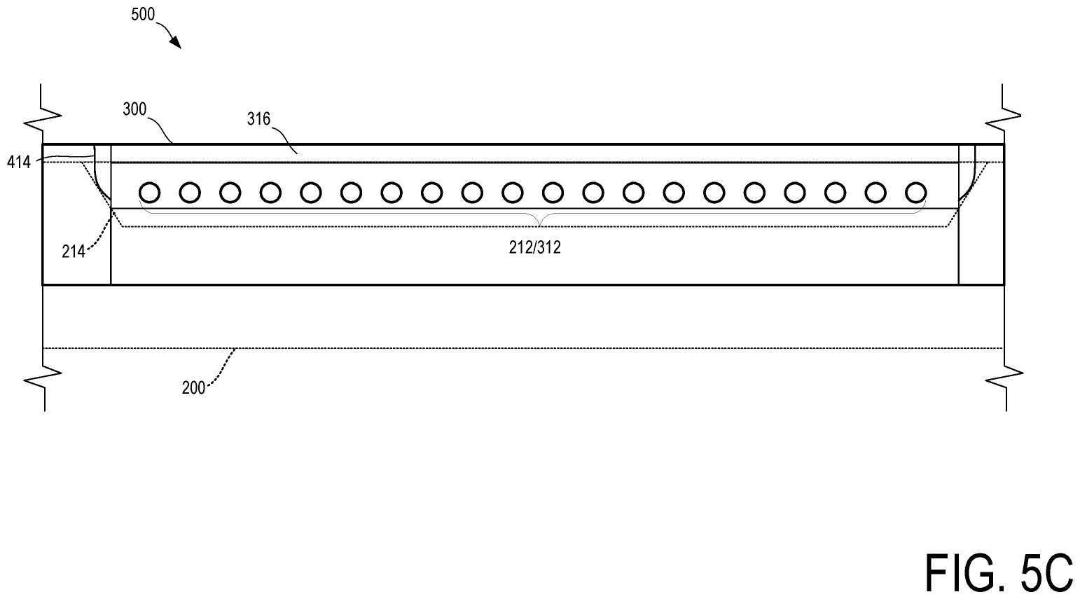

FIGS. 5A-5C illustrate the example PIC die of FIGS. 2A-2B and the FAU of FIGS. 3A-3B coupled together. In particular, FIG. 5A illustrates a perspective view of the coupling of the PIC die 200 and FAU 300, while FIGS. 5B-5C illustrate the coupling via different alignment structures of the FAU 300. As shown, when coupled together, the alignment structures 314/414 of the FAU 300 are in contact with the angled edges 214 of the PIC die 200, causing the waveguides 215/315 to be substantially in alignment with one another (e.g., the cores of the waveguides are aligned enough to properly transmit optical signals therebetween without appreciable signal loss). Further, when coupled together, the angled edges 214 of the PIC die 200 are substantially in alignment with (e.g., in parallel with) the outer edges 313 of the FAU 300. During the attachment process, the waveguides 215/315 may be coupled together using an index-matched epoxy in a similar manner to that used for v-groove attachment techniques. That is, the epoxy may have a refractive index that is substantially the same as the waveguides 215 of the PIC die and the waveguides 315 of the FAU (e.g., within 5-10% of the same indices).

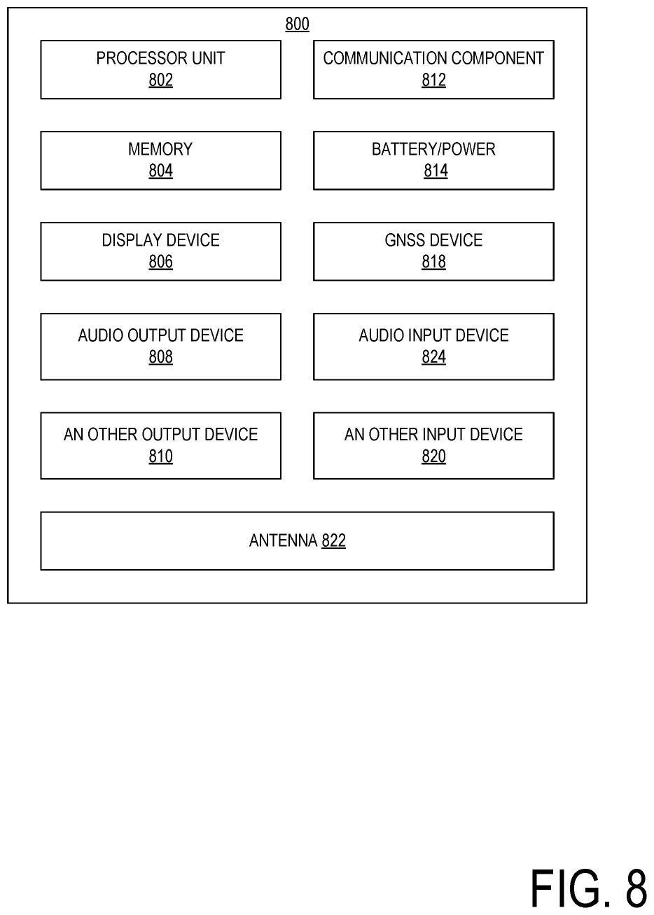

FIG. 6 is a top view of a wafer 600 and dies 602 that may incorporate any of the embodiments disclosed herein. The wafer 600 may be composed of semiconductor material and may include one or more dies 602 having integrated circuit structures formed on a surface of the wafer 600. The individual dies 602 may be a repeating unit of an integrated circuit product that includes any suitable integrated circuit. After the fabrication of the semiconductor product is complete, the wafer 600 may undergo a singulation process in which the dies 602 are separated from one another to provide discrete “chips” of the integrated circuit product. The die 602 may include one or more transistors (e.g., some of the transistors 740 of FIG. 7, discussed below), supporting circuitry to route electrical signals to the transistors, passive components (e.g., signal traces, resistors, capacitors, or inductors), and/or any other integrated circuit components. In some embodiments, the wafer 600 or the die 602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 602. For example, a memory array formed by multiple memory devices may be formed on a same die 602 as a processor unit (e.g., the processor unit 802 of FIG. 8) or other logic that is configured to store information in the memory devices or execute instructions stored in the memory array.

FIG. 7 is a cross-sectional side view of an integrated circuit device 700 that may be included in any of the embodiments disclosed herein. One or more of the integrated circuit devices 700 may be included in one or more dies 602 (FIG. 6). The integrated circuit device 700 may be formed on a die substrate 702 (e.g., the wafer 600 of FIG. 6) and may be included in a die (e.g., the die 602 of FIG. 6). The die substrate 702 may be a semiconductor substrate composed of semiconductor material systems including, for example, n-type or p-type materials systems (or a combination of both). The die substrate 702 may include, for example, a crystalline substrate formed using a bulk silicon or a silicon-on-insulator (SOI) substructure. In some embodiments, the die substrate 702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 702. Although a few examples of materials from which the die substrate 702 may be formed are described here, any material that may serve as a foundation for an integrated circuit device 700 may be used. The die substrate 702 may be part of a singulated die (e.g., the dies 602 of FIG. 6) or a wafer (e.g., the wafer 600 of FIG. 6).

The integrated circuit device 700 may include one or more device layers 704 disposed on the die substrate 702. The device layer 704 may include features of one or more transistors 740 (e.g., metal oxide semiconductor field-effect transistors (MOSFETs)) formed on the die substrate 702. The transistors 740 may include, for example, one or more source and/or drain (S/D) regions 720, a gate 722 to control current flow between the S/D regions 720, and one or more S/D contacts 724 to route electrical signals to/from the S/D regions 720. The transistors 740 may include additional features not depicted for the sake of clarity, such as device isolation regions, gate contacts, and the like. The transistors 740 are not limited to the type and configuration depicted in FIG. 7 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

Returning to FIG. 7, a transistor 740 may include a gate 722 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 740 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 740 along the source-channel-drain direction, the gate electrode may consist of a U-shaped structure that includes a bottom portion substantially parallel to the surface of the die substrate 702 and two sidewall portions that are substantially perpendicular to the top surface of the die substrate 702. In other embodiments, at least one of the metal layers that form the gate electrode may simply be a planar layer that is substantially parallel to the top surface of the die substrate 702 and does not include sidewall portions substantially perpendicular to the top surface of the die substrate 702. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 720 may be formed within the die substrate 702 adjacent to the gate 722 of individual transistors 740. The S/D regions 720 may be formed using an implantation/diffusion process or an etching/deposition process, for example. In the former process, dopants such as boron, aluminum, antimony, phosphorous, or arsenic may be ion-implanted into the die substrate 702 to form the S/D regions 720. An annealing process that activates the dopants and causes them to diffuse farther into the die substrate 702 may follow the ion-implantation process. In the latter process, the die substrate 702 may first be etched to form recesses at the locations of the S/D regions 720. An epitaxial deposition process may then be carried out to fill the recesses with material that is used to fabricate the S/D regions 720. In some implementations, the S/D regions 720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 720 may be formed using one or more alternate semiconductor materials such as germanium or a group III-V material or alloy. In further embodiments, one or more layers of metal and/or metal alloys may be used to form the S/D regions 720.

Electrical signals, such as power and/or input/output (I/O) signals, may be routed to and/or from the devices (e.g., transistors 740) of the device layer 704 through one or more interconnect layers disposed on the device layer 704 (illustrated in FIG. 7 as interconnect layers 706-710). For example, electrically conductive features of the device layer 704 (e.g., the gate 722 and the S/D contacts 724) may be electrically coupled with the interconnect structures 728 of the interconnect layers 706-710. The one or more interconnect layers 706-710 may form a metallization stack (also referred to as an “ILD stack”) 719 of the integrated circuit device 700.

The interconnect structures 728 may be arranged within the interconnect layers 706-710 to route electrical signals according to a wide variety of designs; in particular, the arrangement is not limited to the particular configuration of interconnect structures 728 depicted in FIG. 7. Although a particular number of interconnect layers 706-710 is depicted in FIG. 7. embodiments of the present disclosure include integrated circuit devices having more or fewer interconnect layers than depicted.

In some embodiments, the interconnect structures 728 may include lines 728a and/or vias 728b filled with an electrically conductive material such as a metal. The lines 728a may be arranged to route electrical signals in a direction of a plane that is substantially parallel with a surface of the die substrate 702 upon which the device layer 704 is formed. For example, the lines 728a may route electrical signals in a direction in and out of the page and/or in a direction across the page from the perspective of FIG. 7. The vias 728b may be arranged to route electrical signals in a direction of a plane that is substantially perpendicular to the surface of the die substrate 702 upon which the device layer 704 is formed. In some embodiments, the vias 728b may electrically couple lines 728a of different interconnect layers 706-710 together.

The interconnect layers 706-710 may include a dielectric material 726 disposed between the interconnect structures 728, as shown in FIG. 7. In some embodiments, dielectric material 726 disposed between the interconnect structures 728 in different ones of the interconnect layers 706-710 may have different compositions; in other embodiments, the composition of the dielectric material 726 between different interconnect layers 706-710 may be the same. The device layer 704 may include a dielectric material 726 disposed between the transistors 740 and a bottom layer of the metallization stack as well. The dielectric material 726 included in the device layer 704 may have a different composition than the dielectric material 726 included in the interconnect layers 706-710; in other embodiments, the composition of the dielectric material 726 in the device layer 704 may be the same as a dielectric material 726 included in any one of the interconnect layers 706-710.

A first interconnect layer 706 (referred to as Metal 1 or “M1”) may be formed directly on the device layer 704. In some embodiments, the first interconnect layer 706 may include lines 728a and/or vias 728b, as shown. The lines 728a of the first interconnect layer 706 may be coupled with contacts (e.g., the S/D contacts 724) of the device layer 704. The vias 728b of the first interconnect layer 706 may be coupled with the lines 728a of a second interconnect layer 708.

The second interconnect layer 708 (referred to as Metal 2 or “M2”) may be formed directly on the first interconnect layer 706. In some embodiments, the second interconnect layer 708 may include via 728b to couple the lines 728 of the second interconnect layer 708 with the lines 728a of a third interconnect layer 710. Although the lines 728a and the vias 728b are structurally delineated with a line within individual interconnect layers for the sake of clarity, the lines 728a and the vias 728b may be structurally and/or materially contiguous (e.g., simultaneously filled during a dual-damascene process) in some embodiments.

The third interconnect layer 710 (referred to as Metal 3 or “M3”) (and additional interconnect layers, as desired) may be formed in succession on the second interconnect layer 708 according to similar techniques and configurations described in connection with the second interconnect layer 708 or the first interconnect layer 706. In some embodiments, the interconnect layers that are “higher up” in the metallization stack 719 in the integrated circuit device 700 (i.e., farther away from the device layer 704) may be thicker that the interconnect layers that are lower in the metallization stack 719, with lines 728a and vias 728b in the higher interconnect layers being thicker than those in the lower interconnect layers.

The integrated circuit device 700 may include a solder resist material 734 (e.g., polyimide or similar material) and one or more conductive contacts 736 formed on the interconnect layers 706-710. In FIG. 7, the conductive contacts 736 are illustrated as taking the form of bond pads. The conductive contacts 736 may be electrically coupled with the interconnect structures 728 and configured to route the electrical signals of the transistor(s) 740 to external devices. For example, solder bonds may be formed on the one or more conductive contacts 736 to mechanically and/or electrically couple an integrated circuit die including the integrated circuit device 700 with another component (e.g., a printed circuit board or a package substrate, e.g., 112). The integrated circuit device 700 may include additional or alternate structures to route the electrical signals from the interconnect layers 706-710; for example, the conductive contacts 736 may include other analogous features (e.g., posts) that route the electrical signals to external components.

In some embodiments in which the integrated circuit device 700 is a double-sided die, the integrated circuit device 700 may include another metallization stack (not shown) on the opposite side of the device layer(s) 704. This metallization stack may include multiple interconnect layers as discussed above with reference to the interconnect layers 706-710, to provide conductive pathways (e.g., including conductive lines and vias) between the device layer(s) 704 and additional conductive contacts (not shown) on the opposite side of the integrated circuit device 700 from the conductive contacts 736.

In other embodiments in which the integrated circuit device 700 is a double-sided die, the integrated circuit device 700 may include one or more through silicon vias (TSVs) through the die substrate 702; these TSVs may make contact with the device layer(s) 704, and may provide conductive pathways between the device layer(s) 704 and additional conductive contacts (not shown) on the opposite side of the integrated circuit device 700 from the conductive contacts 736. In some embodiments, TSVs extending through the substrate can be used for routing power and ground signals from conductive contacts on the opposite side of the integrated circuit device 700 from the conductive contacts 736 to the transistors 740 and any other components integrated into the die 700, and the metallization stack 719 can be used to route I/O signals from the conductive contacts 736 to transistors 740 and any other components integrated into the die 700.

Multiple integrated circuit devices 700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

FIG. 8 is a block diagram of an example electrical device 800 that may include one or more of the embodiments disclosed herein. For example, any suitable ones of the components of the electrical device 800 may include one or more of integrated circuit devices 700, or integrated circuit dies 602 disclosed herein. A number of components are illustrated in FIG. 8 as included in the electrical device 800, but any one or more of these components may be omitted or duplicated, as suitable for the application. In some embodiments, some or all of the components included in the electrical device 800 may be attached to one or more motherboards mainboards, or system boards. In some embodiments, one or more of these components are fabricated onto a single system-on-a-chip (SoC) die.

Additionally, in various embodiments, the electrical device 800 may not include one or more of the components illustrated in FIG. 8, but the electrical device 800 may include interface circuitry for coupling to the one or more components. For example, the electrical device 800 may not include a display device 806, but may include display device interface circuitry (e.g., a connector and driver circuitry) to which a display device 806 may be coupled. In another set of examples, the electrical device 800 may not include an audio input device 824 or an audio output device 808, but may include audio input or output device interface circuitry (e.g., connectors and supporting circuitry) to which an audio input device 824 or audio output device 808 may be coupled.

The electrical device 800 may include one or more processor units 802 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 802 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 800 may include a memory 804, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 804 may include memory that is located on the same integrated circuit die as the processor unit 802. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 800 can comprise one or more processor units 802 that are heterogeneous or asymmetric to another processor unit 802 in the electrical device 800. There can be a variety of differences between the processing units 802 in a system in terms of a spectrum of metrics of merit including architectural, microarchitectural, thermal, power consumption characteristics, and the like. These differences can effectively manifest themselves as asymmetry and heterogeneity among the processor units 802 in the electrical device 800.

In some embodiments, the electrical device 800 may include a communication component 812 (e.g., one or more communication components). For example, the communication component 812 can manage wireless communications for the transfer of data to and from the electrical device 800. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 812 may operate in accordance with

Enhanced Data for GSM Evolution (EDGE), GSM EDGE Radio Access Network (GERAN), Universal Terrestrial Radio Access Network (UTRAN), or Evolved UTRAN (E-UTRAN). The communication component 812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 812 may operate in accordance with other wireless protocols in other embodiments. The electrical device 800 may include an antenna 822 to facilitate wireless communications and/or to receive other wireless communications (such as AM or FM radio transmissions).

In some embodiments, the communication component 812 may manage wired communications, such as electrical, optical, or any other suitable communication protocols (e.g., IEEE 802.3 Ethernet standards). As noted above, the communication component 812 may include multiple communication components. For instance, a first communication component 812 may be dedicated to shorter-range wireless communications such as Wi-Fi or Bluetooth, and a second communication component 812 may be dedicated to longer-range wireless communications such as global positioning system (GPS), EDGE, GPRS, CDMA, WiMAX, LTE, EV-DO, or others. In some embodiments, a first communication component 812 may be dedicated to wireless communications, and a second communication component 812 may be dedicated to wired communications.

The electrical device 800 may include battery/power circuitry 814. The battery/power circuitry 814 may include one or more energy storage devices (e.g., batteries or capacitors) and/or circuitry for coupling components of the electrical device 800 to an energy source separate from the electrical device 800 (e.g., AC line power).

The electrical device 800 may include a display device 806 (or corresponding interface circuitry, as discussed above). The display device 806 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 800 may include an audio output device 808 (or corresponding interface circuitry, as discussed above). The audio output device 808 may include any embedded or wired or wirelessly connected external device that generates an audible indicator, such speakers, headsets, or earbuds.

The electrical device 800 may include an audio input device 824 (or corresponding interface circuitry, as discussed above). The audio input device 824 may include any embedded or wired or wirelessly connected device that generates a signal representative of a sound, such as microphones, microphone arrays, or digital instruments (e.g., instruments having a musical instrument digital interface (MIDI) output). The electrical device 800 may include a Global Navigation Satellite System (GNSS) device 818 (or corresponding interface circuitry, as discussed above), such as a Global Positioning System (GPS) device. The GNSS device 818 may be in communication with a satellite-based system and may determine a geolocation of the electrical device 800 based on information received from one or more GNSS satellites, as known in the art.

The electrical device 800 may include another output device 810 (or corresponding interface circuitry, as discussed above). Examples of the other output device 810 may include an audio codec, a video codec, a printer, a wired or wireless transmitter for providing information to other devices, or an additional storage device.

The electrical device 800 may include another input device 820 (or corresponding interface circuitry, as discussed above). Examples of the other input device 820 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 800 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 800 may be any other electronic device that processes data. In some embodiments, the electrical device 800 may comprise multiple discrete physical components. Given the range of devices that the electrical device 800 can be manifested as in various embodiments, in some embodiments, the electrical device 800 can be referred to as a computing device or a computing system.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 is an integrated circuit die comprising: a substrate; optical circuit components coupled to the substrate; a plurality of waveguides coupled to the optical circuit components; and a cavity at an outer edge of the apparatus, the cavity defined by a first edge, a second edge, a third edge, and a bottom surface; wherein the plurality of waveguides protrude from the first edge of the cavity, and the second edge and the third edge are at an angle less than 90 degrees with respect to the bottom surface of the cavity.

Example 2 includes the subject matter of Example 1, wherein the second edge and the third edge are angled at approximately 45 degrees with respect to the bottom surface of the cavity.

Example 3 includes the subject matter of Example 1 or 2, wherein the first edge is substantially perpendicular with the bottom surface of the cavity.

Example 4 includes the subject matter of any one of Examples 1-3, wherein the second edge and the third edge are substantially parallel with one another.

Example 5 includes the subject matter of any one of Examples 1-4, further comprising alignment fiducials on a top surface of the substrate.

Example 6 is a fiber coupling apparatus comprising: a body portion; a shelf portion extending from the body portion, the shelf portion defined at least partially by a first edge opposite the body portion, a second edge, and a third edge; a plurality of waveguides protruding from the first edge of the shelf portion; a first alignment structure extending from the second edge of the shelf portion; and a second alignment structure extending from the third edge of the shelf portion.

Example 7 includes the subject matter of Example 6, wherein the first alignment structure and the second alignment structure each comprise flat outer edges.

Example 8 includes the subject matter of Example 6, wherein the first alignment structure and the second alignment structure each comprise curved outer edges.

Example 9 includes the subject matter of any one of Examples 6-8, wherein the second edge and the third edge are substantially perpendicular to the first edge.

Example 10 includes the subject matter of any one of Examples 6-9, further comprising: a third alignment structure extending from the second edge of the shelf portion; and a fourth alignment structure extending from the third edge of the shelf portion.

Example 11 includes the subject matter of any one of Examples 6-10, wherein the body portion and the shelf portion comprise glass.

Example 12 is a device comprising: a photonics integrated circuit (PIC) die, the PIC die comprising: a cavity defined at an edge of the PIC die, wherein the cavity is defined by a first edge, a second edge, a third edge, and a bottom surface, wherein the second edge and the third edge are at an angle less than 90 degrees with respect to the bottom surface of the cavity; a plurality of first waveguides protruding into the cavity of the PIC die from the first edge; and a fiber array unit (FAU) coupled to the PIC die, the FAU comprising: a body portion; a shelf portion extending from the body portion, the shelf portion defined at least partially by a first edge opposite the body portion, a second edge, and a third edge; a plurality of second waveguides protruding from the first edge of the shelf portion; a first alignment structure on the second edge of the shelf portion, the first alignment structure in contact with the second edge of the cavity of the PIC die; and a second alignment structure on the third edge of the shelf portion, the second alignment structure in contact with the third edge of the cavity of the PIC die.

Example 13 includes the subject matter of Example 12, wherein the first alignment structure and the second alignment structure each comprise flat edges in contact with the second edge and the third edge of the PIC die, respectively.

Example 14 includes the subject matter of Example 12, wherein the first alignment structure and the second alignment structure each comprise curved edges in contact with the second edge and the third edge of the PIC die, respectively.

Example 15 includes the subject matter of any one of Examples 12-14, wherein the second edge of the PIC die and the third edge of the PIC die are angled at approximately 45 degrees.

Example 16 includes the subject matter of any one of Examples 12-15, wherein the first edge of the PIC die is substantially perpendicular with the bottom surface of the cavity.

Example 17 includes the subject matter of any one of Examples 12-16, wherein the second edge of the PIC die and the third edge of the PIC die are substantially parallel with one another, and the second edge of the FAU and the third edge of the FAU are substantially parallel with one another.

Example 18 includes the subject matter of any one of Examples 12-17, wherein the

second edge of the PIC die is substantially in alignment with the second edge of the FAU and the third edge of the PIC die is substantially in alignment with the third edge of the FAU.

Example 19 includes the subject matter of any one of Examples 12-18, further

comprising epoxy between the first waveguides and the second waveguides, the epoxy having a refractive index that is substantially the same as the first waveguides and the second waveguides.

Example 20 includes the subject matter of any one of Examples 12-19, wherein the

first waveguides are substantially in alignment with the second waveguides.

Example 21 includes the subject matter of any one of Examples 12-20, wherein the body portion and the shelf portion of the FAU comprise glass.

Example 22 is a device that includes a fiber array unit (FAU) coupled to a photonics integrated circuit (PIC) die. The PIC die includes a cavity defined at an edge of the PIC die, with outer edges of the cavity being formed at an angle less than 90 degrees with respect to a bottom surface of the cavity. The PIC die further includes first waveguides protruding into the cavity of the PIC die. The FAU includes a shelf portion extending from a body portion, and a plurality of second waveguides protruding from an outer edge of the shelf portion opposite the body portion.

The FAU further includes alignment structures on outer edges of the shelf portion that are in contact with the angled edges of the cavity of the PIC die.

Example 23 includes the subject matter of Example 22, wherein the first alignment structure and the second alignment structure each comprise flat edges in contact with the second edge and the third edge of the PIC die, respectively.

Example 24 includes the subject matter of Example 22, wherein the first alignment structure and the second alignment structure each comprise curved edges in contact with the second edge and the third edge of the PIC die, respectively.

Example 25 includes the subject matter of any one of Examples 22-14, wherein the second edge of the PIC die and the third edge of the PIC die are angled at approximately 45 degrees.

Example 26 includes the subject matter of any one of Examples 22-15, wherein the first edge of the PIC die is substantially perpendicular with the bottom surface of the cavity.

Example 27 includes the subject matter of any one of Examples 22-16, wherein the second edge of the PIC die and the third edge of the PIC die are substantially parallel with one another, and the second edge of the FAU and the third edge of the FAU are substantially parallel with one another.

Example 28 includes the subject matter of any one of Examples 22-17, wherein the

second edge of the PIC die is substantially in alignment with the second edge of the FAU and the third edge of the PIC die is substantially in alignment with the third edge of the FAU.

Example 29 includes the subject matter of any one of Examples 22-18, further

comprising epoxy between the first waveguides and the second waveguides, the epoxy having a refractive index that is substantially the same as the first waveguides and the second waveguides.

Example 30 includes the subject matter of any one of Examples 22-19, wherein the

first waveguides are substantially in alignment with the second waveguides.

Example 31 includes the subject matter of any one of Examples 22-30, wherein the body portion and the shelf portion of the FAU comprise glass.

Example 32 is a device that includes the fiber coupling apparatus of any one of Examples 6-11 coupled to the integrated circuit die of any one of Examples 1-5.

In the above description, various aspects of the illustrative implementations have been described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials, and configurations have been set forth to provide a thorough understanding of the illustrative implementations. However, it will be apparent to one skilled in the art that the present disclosure may be practiced without all of the specific details. In other instances, well-known features have been omitted or simplified in order not to obscure the illustrative implementations.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

The terms “over,” “under,” “between,” “above,” and “on” as used herein may refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening features.

The above description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

In various embodiments, the phrase “a first feature formed, deposited, or otherwise disposed on a second feature” may mean that the first feature is formed, deposited, or disposed over the second feature, and at least a part of the first feature may be in direct contact (e.g., direct physical and/or electrical contact) or indirect contact (e.g., having one or more other features between the first feature and the second feature) with at least a part of the second feature.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

1. An integrated circuit die comprising:
a substrate;
optical circuit components coupled to the substrate;
a plurality of waveguides coupled to the optical circuit components; and
a cavity at an outer edge of the die, the cavity defined by a first edge, a second edge, a third edge, and a bottom surface;
wherein the plurality of waveguides protrude from the first edge of the cavity, and the second edge and the third edge are at an angle less than 90 degrees with respect to the bottom surface of the cavity.

2. The integrated circuit die of claim 1, wherein the second edge and the third edge are angled at approximately 45 degrees with respect to the bottom surface of the cavity.

3. The integrated circuit die of claim 1, wherein the first edge is substantially perpendicular with the bottom surface of the cavity.

4. The integrated circuit die of claim 1, wherein the second edge and the third edge are substantially parallel with one another.

5. The integrated circuit die of claim 1, further comprising alignment fiducials on a top surface of the substrate.

6. A fiber coupling apparatus comprising:
a body portion;
a shelf portion extending from the body portion, the shelf portion defined at least partially by a first edge opposite the body portion, a second edge, and a third edge;
a plurality of waveguides protruding from the first edge of the shelf portion;
a first alignment structure extending from the second edge of the shelf portion; and
a second alignment structure extending from the third edge of the shelf portion.

7. The apparatus of claim 6, wherein the first alignment structure and the second alignment structure each comprise flat outer edges.

8. The apparatus of claim 6, wherein the first alignment structure and the second alignment structure each comprise curved outer edges.

9. The apparatus of claim 6, wherein the second edge and the third edge are substantially perpendicular to the first edge.

10. The apparatus of claim 6, further comprising:
a third alignment structure extending from the second edge of the shelf portion; and
a fourth alignment structure extending from the third edge of the shelf portion.

11. The apparatus of claim 6, wherein the body portion and the shelf portion comprise glass.

12. A device comprising:
a photonics integrated circuit (PIC) die, the PIC die comprising:
a cavity defined at an edge of the PIC die, wherein the cavity is defined by a first edge, a second edge, a third edge, and a bottom surface, wherein the second edge and the third edge are at an angle less than 90 degrees with respect to the bottom surface of the cavity;
a plurality of first waveguides protruding into the cavity of the PIC die from the first edge; and
a fiber array unit (FAU) coupled to the PIC die, the FAU comprising:
a body portion;
a shelf portion extending from the body portion, the shelf portion defined at least partially by a first edge opposite the body portion, a second edge, and a third edge;
a plurality of second waveguides protruding from the first edge of the shelf portion;
a first alignment structure on the second edge of the shelf portion, the first alignment structure in contact with the second edge of the cavity of the PIC die; and
a second alignment structure on the third edge of the shelf portion, the second alignment structure in contact with the third edge of the cavity of the PIC die.

13. The device of claim 12, wherein the first alignment structure and the second alignment structure each comprise flat edges in contact with the second edge and the third edge of the PIC die, respectively.

14. The device of claim 12, wherein the first alignment structure and the second alignment structure each comprise curved edges in contact with the second edge and the third edge of the PIC die, respectively.

15. The device of claim 12, wherein the second edge of the PIC die and the third edge of the PIC die are angled at approximately 45 degrees.

16. The device of claim 12, wherein the first edge of the PIC die is substantially perpendicular with the bottom surface of the cavity.

17. The device of claim 12, wherein the second edge of the PIC die and the third edge of the PIC die are substantially parallel with one another, and the second edge of the FAU and the third edge of the FAU are substantially parallel with one another.

18. The device of claim 12, wherein the second edge of the PIC die is substantially in alignment with the second edge of the FAU and the third edge of the PIC die is substantially in alignment with the third edge of the FAU.

19. The device of claim 12, further comprising epoxy between the first waveguides and the second waveguides, the epoxy having a refractive index that is substantially the same as the first waveguides and the second waveguides.

20. The device of claim 12, wherein the body portion and the shelf portion of the FAU comprise glass.
